(19) United States
(12) Patent Application Publication
(10) Pub. No.: US 2012/0155858 A1
(43) Pub. Date: Jun. 21, 2012

(54) OPTICAL NETWORK DEVICE, OPTICAL NETWORK SYSTEM, MALFUNCTION DETECTING METHOD FOR OPTICAL NETWORK DEVICE, AND MALFUNCTION DETECTING PROGRAM FOR OPTICAL NETWORK DEVICE

(75) Inventor: Hirokazu Ozaka, Tokyo (JP)

(73) Assignee: NEC Corporation, Minato-ku, Tokyo (JP)

(21) Appl. No.: 13/393,476

(22) PCT Filed: Aug. 24, 2010
(86) PCT No.: PCT/JP2010/064661

§ 371 Date: Feb. 29, 2012

(30) Foreign Application Priority Data
Sep. 1, 2009 (JP) 2009-201530

(51) Int. Cl. H04B 10/08

(52) U.S. Cl. 398/24

(57) ABSTRACT

Provided is an optical network system having a plural of slave-station devices, in that it is possible for a master-station device to efficiently identify malfunctioning slave-station devices, even in the case that a plurality of slave-station devices are malfunctioning.

It includes a transmission means which, for a plurality of slave station devices which are grouped, successively designates a group of the above-mentioned slave station device, emits signal light of all above-mentioned slave station devices in the designated group after transmitting from the master station device a control signal which forces to emit or eliminat a signal light, eliminates all above-mentioned slave station devices in the groups other than the designated group, and executes a light emitting and eliminating control process, and a selection and refinement means which determines whether or not it can properly receive the signal light from the above-mentioned slave station device in the above-mentioned designated group, and directs the above-mentioned transmission means to execute the above-mentioned light emitting and eliminating control process for each group which is divided further for the group which is determined that it cannot properly receive the signal light.

### TECHNICAL FIELD

The present invention relates to an optical data communication network which connects between a master station device and a plurality of slave station devices, and in particular relates to a technology of identifying malfunctioning slave station devices at the master station device side in an optical network system wherein a large number of the slave station devices are connected by branching optical fibers.

### BACKGROUND ART

A broadbandization of access line is becoming popular in accordance with progresses of the Internet. Various methods including ADSL (Asymmetric Digital Subscriber Line) and cable modem or the like are already in practical use for the broadband access line. In particular, PON (Passive Optical Network) is attracting considerable attention for further increase of bandwidth, and is becoming popular throughout the world. Recently, a PON system having gigabit class interface rates is also in practical use.

FIG. 6A and FIG. 6B show basic structures of the PON system. An ONU (Optical Network Unit) is installed at an end user's home as a slave station device, and an OLT (Optical Line Terminator) is installed in a station as a master station device. These devices are connected each other using optical fibers and Optical Splitters. Note that a plural of Optical Splitters are connected in tandem in the case that a multiple branches and combinations are required.

Respective user's PC is connected with the network via the ONU, and is further connected with an upper layer network and the Internet via the OLT. The master station device and the slave station device can be connected each other with single core bidirectional optical fibers by wavelength multiplexing of signals for upstream direction (wavelength of 1.3□m is usually used) and signals for downstream direction (wavelength of 1.5□m is usually used).

The signal of the downstream direction is broadcasted from the OLT to all the ONUs, and each ONU checks address of a frame in the signal and receives a frame addressed to the local device. On the other hand, because the signal of the upstream direction from each ONU merges at the Optical Splitters, time division multiplexing is used in order that a collision of the signals does not happen in this case. In this case, the OLT mediates a REPORT (i.e. output request) which is continuously reported from each ONU, calculates a transmission time based on distance between the OLT and the ONUs, and delivers the GATE (i.e. permission of signal output) to each ONU. The REPORT includes information on a state of the queue of a buffer (i.e. length of queue). The GATE includes a transmission start time and a transmission duration time according to priority of each signal, and the ONU transmits the upstream signal based on these times. That is, bandwidth allocation of the upstream direction is realized by allocations of time slots. FIG. 6A and FIG. 6B show a stream of signals in the case that the OLT accommodates one PON system and connects three ONUs. FIG. 6A shows a state that signals propagate in the downstream direction, and FIG. 6B shows a state that signals propagate in the upstream direction respectively. Those squares having a number in it in FIG. 6A and FIG. 6B indicate frames of signal addressed to each ONU and signals transmitted from each ONU. Further, because a distance between the OLT and the ONU is different, it is requested to measure round-trip time of a signal on each ONU at the time of startup in order for the OLT to deliver appropriate GATEs. This is called a start-up process of PON system.

The OLT which is the master station device of PON system generally accommodates a plurality of PON systems and has a function of concentrating and separating those signals. A PON interface unit of the OLT includes an input and output function of the PON system, a signal termination function, and a device internal interface function or the like. FIG. 7 shows an example where an OLT includes one PON interface unit, and accommodates one hundred and twenty-eight ONUs by three stages with forty-one Optical Splitters consisting of one first stage (1:8), eight second stages (1:4), and thirty-two third stages (1:4). A trend shows that number of branches is increasing for the future, and an example of 1024 branches is already reported at an experimental trial product level.

Incidentally, there is a malfunctioning mode where the signal of the upstream direction will be permanently emitting (i.e. incomplete light eliminating) as one of a malfunction of the ONU at the slave station device. Because a light which is permanently emitting collides with the upstream signals from other ONUs and obstruct these signals, the OLT cannot receive any more the upstream signals. Under the situation, it is difficult at the OLT side to determine which in a large number of the ONUs is causing the permanent light emitting, because the upstream signal is concentrated in single optical fiber at the OLT side and is received.

In order to overcome this kind of problem, the Japanese Patent Application Laid-Open No. 2004-112746 (referred to as patent document 1) discloses a technological example of identifying ONUs which has caused the incomplete light eliminating. The technology on how to specify a malfunctioning ONU is disclosed in the patent document 1 and it is disclosed as follows. In the PON system where the ONUs at a plural of slave station devices are connected to the OLT of the master station side, in the case that an incomplete light eliminating occurs in one of the ONU, the OLT successively transmits a signal including a eliminating command after designating a specific ONU among entire ONUs. Each ONU which received the above-mentioned command turns off emission of light of the local station. Then, in the case that the permanent light emitting signal (i.e. background light) which the OLT receives is eliminated because the ONU which caused the incomplete light eliminating turns off emission of light following to the above-mentioned command, the OLT can identify the ONU which is causing the incomplete light eliminating.

Note that, even though it takes a lot of efforts and times in the case that there are a lot of ONUs according to the above described step by step checking process of the ONUs, the patent document 1 also discloses a method of the following variation example where it can efficiently detect malfunctioning ONUs. That is, the connected ONUs are divided into two groups and the OLT transmits the eliminating command to one of two group. If a permanent light emitting signal which the OLT receives is eliminated in the case that one of two groups is entirely eliminated, it determines that a malfunctioning ONU exists in the group, and if the permanent light emitting signal is not eliminated, it determines that the malfunctioning ONU exists in the other group. Then, the group in which it is determined that the malfunctioning ONU is included is divided further into two groups, and identifies a group in which the malfunctioning ONU is included in the same manner. In this way, by refining the groups in which malfunctioning ONU is included, it can efficiently detect the malfunctioning ONU.

### DISCLOSURE OF THE INVENTION

### Problem to be Solved by the Invention

However, because a technology of specifying a malfunctioning ONU mentioned above cannot identify a malfunctioning ONU if more than one malfunctioning ONUs exist among all the ONUs that are connected to the OLT, there is a problem that it cannot identify these malfunctioning ONUs in the case that a plurality of ONUs are simultaneously in the malfunction.

The reason is because; in the case that a plurality of ONUs are concurrently causing malfunctions of the incomplete light eliminating, even though it transmits the eliminating command and stops emitting to one of the malfunctioning ONUs, the OLT keeps receiving the permanent light emitting as the background light in the case that there exist other ONUs whose output lights are incompletely eliminated. That is, in this case, even though the OLT eliminates one of the malfunctioning ONUs, reception of a normal signal is still interfered by a permanent light emitted from other malfunctioning ONUs, and the OLT cannot detect a change of state. Moreover, it is quite similar for a method where ONUs are divided into two groups and the target ONU is gradually specified by the determination of which group does malfunctioning ONU include among two groups being repeated. That is, in the case that there is an assumption that there exists single malfunctioning ONU, when the permanent light emitting signal does not go off even if it eliminates all the ONUs which belong to one group, it can determine that the malfunctioning ONU may exist in the other group. However, in the case that a plurality of malfunctioning ONUs may exist, because it cannot determine whether or not the malfunctioning ONUs are included in a group which is eliminated, it is impossible to identify a group which includes the malfunctioning ONUs.

The object of the present invention is to settle the above-mentioned problem. Further, the present invention provides an optical network device, an optical network system, a malfunction detecting method for the optical network device, and a malfunction detecting program for the optical network device which can identify malfunctioning slave station devices efficiently in spite of its number at the master station side.

### Means for Solving the Problem

An optical network device of the present invention is the optical network device which is connected via a branched optical fiber with at least two slave station devices wherein it comprises a transmission means which transmits a control signal including an emitting command to, among the at least two slave station devices which are divided into at least two groups that exclusively include them, all the slave station devices which belong to a group selected from the at least two groups, transmits a control signal including an eliminating command to all the slave station devices which belong to a group other than the selected group, and executes these light emitting and eliminating control processes for each of the at least two groups, and a selection and refinement means which determines for the selected group whether or not it can properly receive a signal light which the slave station device which belongs to the group emits after the execution of the light emitting and eliminating control process, and directs the transmission means to execute the above-mentioned light emitting and eliminating control process for each group which is further divided from the group which is determined that it cannot properly receive the signal light.

In addition, in an optical network system according to the present invention, the optical network device according to the present invention is connected with at least two slave station devices via a branched optical fiber.

Further, malfunction detecting method for the optical network device according to the present invention is the malfunction detecting method for the optical network device in the optical network system wherein the master station device is connected with at least two slave station devices via a branched optical fiber, including a transmission step which transmits a control signal including an emitting command to, among the at least two slave station devices which are divided into at least two groups that exclusively include them, all the slave station devices which belong to a group selected from the at least two groups, transmits a control signal including an eliminating command to all the slave station devices which belong to a group other than the selected group, and executes these light emitting and eliminating control processes for each of the at least two groups, and a selection and refinement step which determines for the selected group whether or not it can properly receive a signal light which the slave station device which belongs to the group emits after the execution of the light emitting and eliminating control process, and directs the transmission means to execute the light emitting and eliminating control process for each group which is further divided from the group which is determined that it cannot properly receive the signal light.

Moreover, a malfunction detecting program of the optical network device of the present invention is the malfunction detecting program of the optical network device in the optical network system wherein the master station device is connected with at least two slave station devices via a branched optical fiber, includes a transmission procedure which transmits a control signal including an emitting command to, among the at least two slave station devices which are divided into at least two groups that exclusively include them, all the slave station devices which belong to a group selected from the at least two groups, transmits a control signal including an eliminating command to all the slave station devices which belong to a group other than the selected group, and executes these light emitting and eliminating control processes for each of the at least two groups, and a selection and refinement procedure which determines for the selected group whether or not it can properly receive a signal light which the slave station device which belongs to the group emits after the execution of the light emitting and eliminating control process, and directs the transmission means to execute the light emitting and eliminating control process for each group which is further divided from the group which is determined that it cannot properly receive the signal light.

### Effect of the Invention

As described above, according to the present invention, even in the case that the optical network system has a large number of slave station devices, master station device can efficiently identifies malfunctioning slave station devices even if a malfunction occurs on a plurality of slave station devices.

### BRIEF DESCRIPTION OF THE DRAWING

FIG. 1 is a configuration diagram showing an optical network system according to an embodiment of the present invention.

FIG. 2 is a configuration diagram showing a PON system according to another embodiment of the present invention.

FIG. 3 is a configuration diagram showing the PON system according to another embodiment of the present invention.

FIG. 4 is a flowchart showing a procedure according to the embodiment of the present invention.

FIG. 5 is a schematic diagram showing stages of grouping of ONUs.

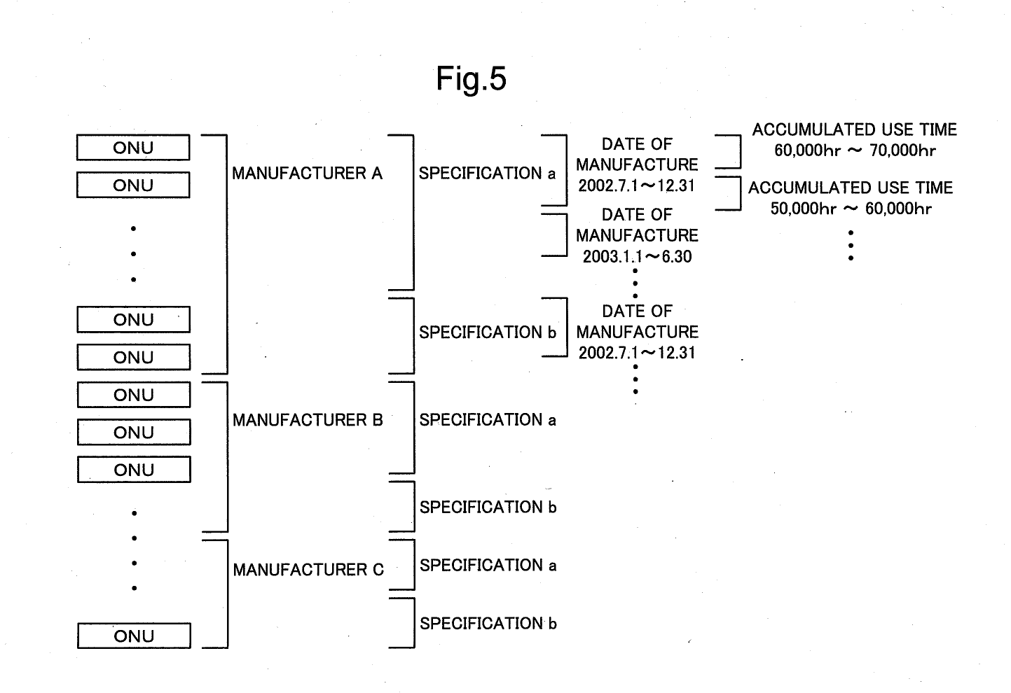

FIG. 6A is a configuration diagram showing a basic configuration of the PON system.

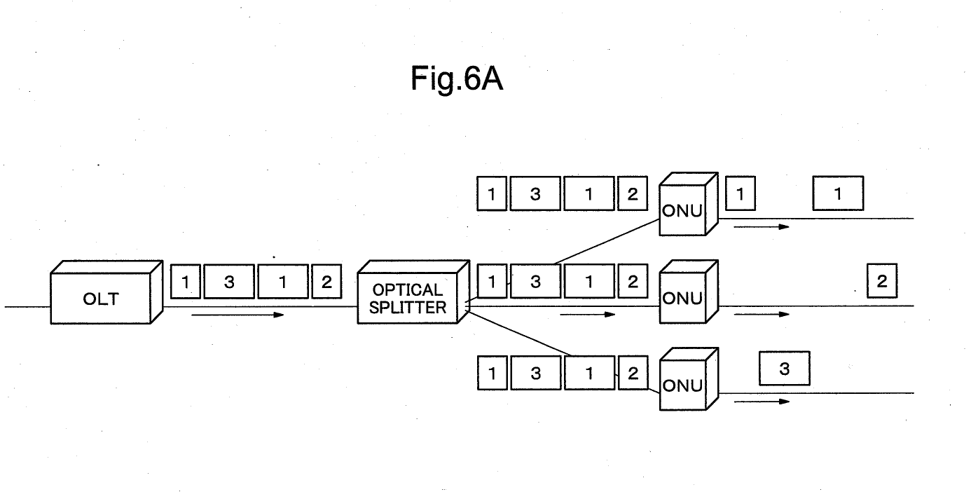

FIG. 6B is a configuration diagram showing a basic configuration of the PON system.

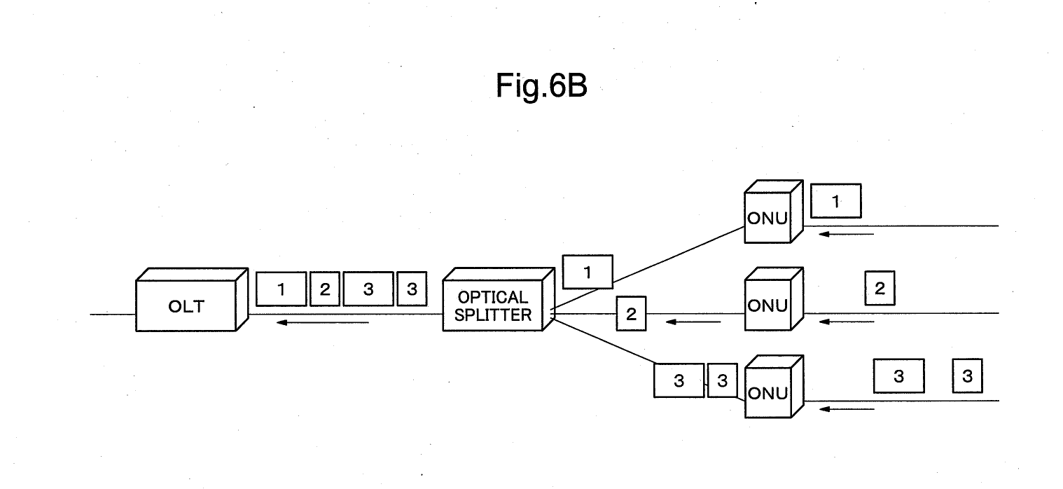

FIG. 7 is a configuration diagram showing an example of a multi-branch type PON system.

### DESCRIPTION OF EMBODIMENTS

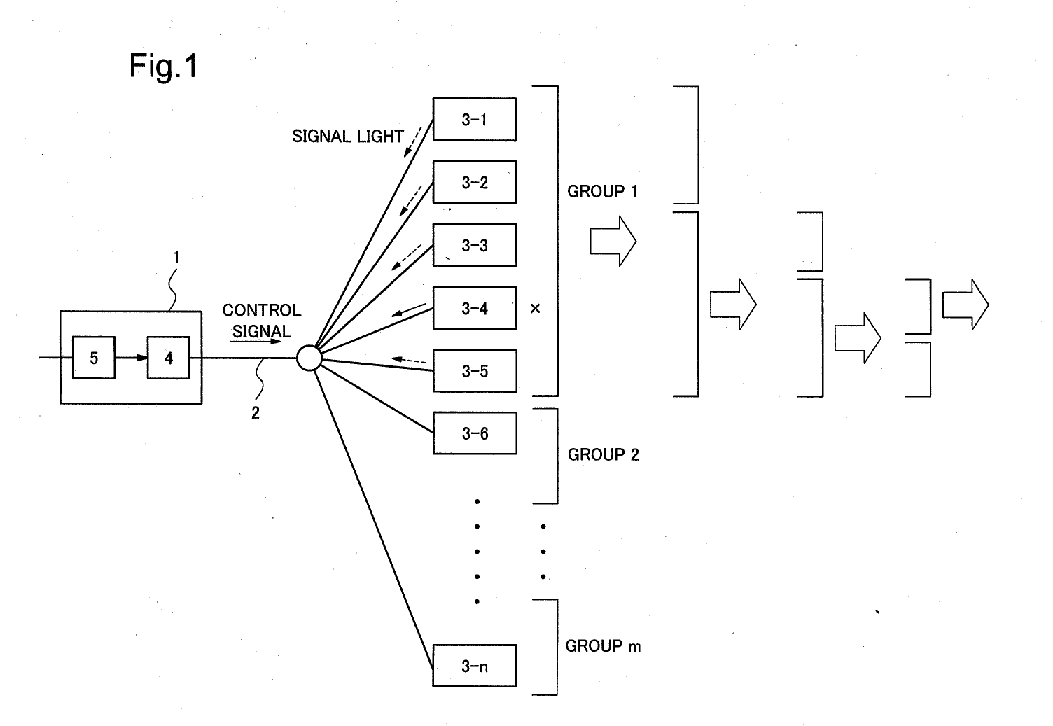

Next, embodiments of the present invention are described by referring to the drawings. FIG. 1 is the configuration diagram showing the configuration according to one of the embodiments of the present invention. With referring to FIG. 1, the optical network system according to the embodiment includes an optical network system where an optical fiber cable 2 from a master station device 1 is branched and connected with at least two slave station devices 3-1 to 3-n (n: natural number of no smaller than 2).

These slave station devices 3-1 to 3-n are divided into at least two groups 1 to m (m: natural number of no smaller than 2), where each group respectively includes at least one slave station device. Note that, all the slave station devices belong to any one of the groups, and at the same time, the same slave station device does not belong to different groups. The master station device 1 includes a transmission means 4 which transmits a control signal including an emitting command for emitting a signal light or an eliminating command for eliminating a signal light to the slave station device 3-1 to 3-n.

By using the transmission means 4, the master station device 1 successively designates one group among the groups of the slave station devices 1 to m, and transmits the control signal including the emitting command to all the slave station devices which belong to the designated group. On the other hand, the master station device 1 transmits the control signal including the eliminating command to all the slave station devices which belong to a group other than the designated group.

In addition, the master station device 1 includes a selection and refinement means 5, and determines whether or not it can properly receive the signal light from the slave station devices which belong to the group which is designated to emit the light.

A group which is determined that it cannot properly receive the signal light is further divided into groups which are smaller than the designated group, and identifies a group which cannot properly receive the signal light using the transmission means and the selection and refinement means. By repeating the procedure, it identifies a group which cannot properly receive the signal light.

As described above, according to the embodiment, it determines whether or not it can properly receive the signal light from the slave station devices which belong to a group for each group of the slave station devices, and identifies a group wherein it cannot properly receive the signal light because it includes a slave station device which caused the malfunction of the incomplete light eliminating. Accordingly, even if a plurality of slave station devices may exist which caused a malfunction of the incomplete light eliminating, it can respectively identify these groups which include the slave station devices which caused the malfunction of the incomplete light eliminating. Then, for the optical network system having a large number of slave station devices, by identifying a group which includes a slave station device which caused the malfunction of the incomplete light eliminating, it can efficiently identify the slave station devices which have caused the malfunction of the incomplete light eliminating in spite of number of the slave stations.

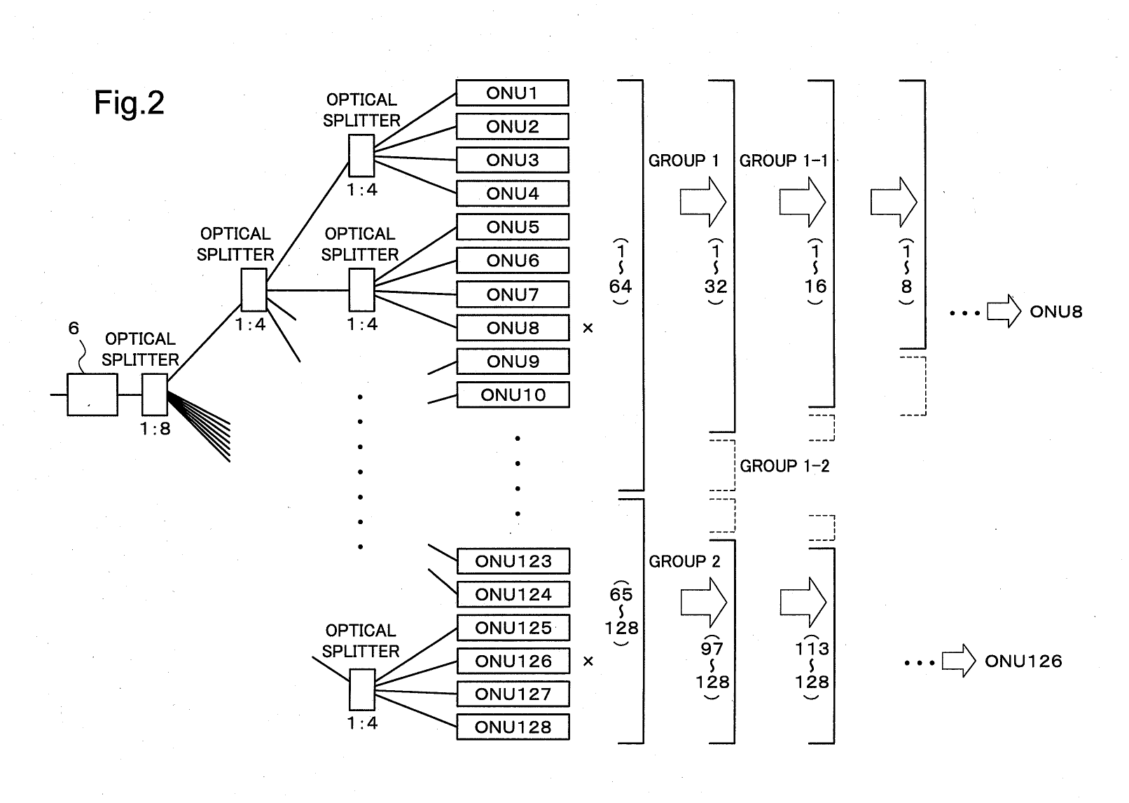

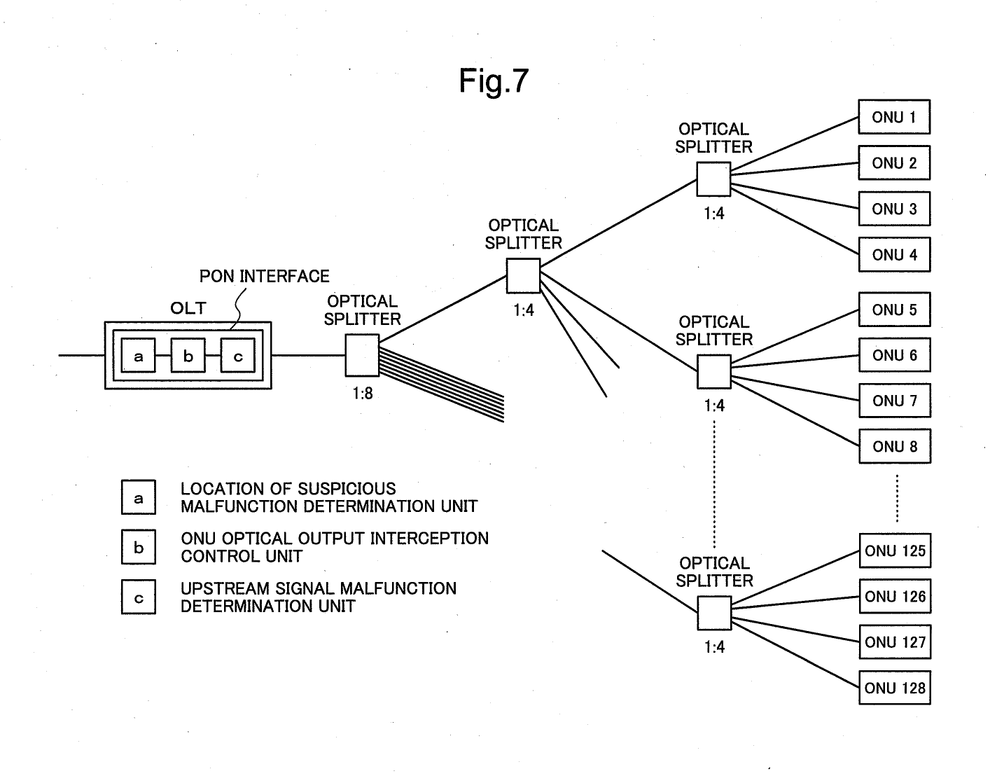

Next, a configuration and an operation of another embodiment of the present invention by taking a PON system as an example is described concretely in detail. FIG. 2 is a similar optical network system as the PON system shown in FIG. 7. With referring to FIG. 2, a fiber cable from an OLT 6 which is the master station device is branched to three stages and connected with an ONU 1 to an ONU 128 which are the slave station devices.

The ONU 1 to the ONU 128 are divided into two groups consisting of group 1 (ONU 1 to ONU 64) and group 2 (ONU 65 to ONU 128). The OLT 6 has a mechanism of transmitting the control signal including the emitting command which emits the signal light or a eliminating command which eliminates it respectively to the ONU 1 to the ONU 128, and the ONU 1 to the ONU 128 emits or eliminates the signal light following to the above-mentioned command when they receive the above-mentioned control signal. And, each ONU continues the state of emitting or eliminating of the signal light until it receives a next control signal. For a group which includes a malfunctioning ONU which is in the incomplete light eliminating, the OLT6 cannot properly receive any signal light from the ONUs in the group due to interference by the permanent light emitting.

Followings are descriptions of the malfunctioning device detecting operation according to the embodiment. It is supposed that, as an example, ONU 8 and ONU 126 are causing malfunctions of the incomplete light eliminating and are always emitting.

At first, the OLT 6 designates the group 1 and transmits the control signal including the emitting command to the ONU 1 to the ONU 64 which belong to the group 1, and forces to emit the signal light. On the other hand, it transmits the control signal including the eliminating command to all ONUs which belong to the group 2 including the ONU 126 which is causing the incomplete light eliminating, and they compulsorily stops emitting. Here, because the ONU 8 which belongs to the group 1 always emits the light and the signal lights from all ONUs which belong to the group 1 are interfered by the light, the OLT 6 cannot properly receive the signal lights. Accordingly, it can determine that at least one among the ONU 1 to the ONU 64 has a malfunction in the group 1. At this stage, it can determine that malfunctioning ONUs exist in the group 1, but it cannot determine whether or not there are malfunctioning ONUs in the group 2.

Then, the OLT 6 designates the group 2 and transmits the control signal including the emitting command to the ONU 65 to the ONU 128 which belong to the group 2, and they start emitting the signal light. On the other hand, the OLT 6 transmits the control signal including the eliminating command to all ONUs which belong to the group 1, and they compulsorily stop emission. In this case, because the ONU 126 is causing the incomplete light eliminating, the OLT6 cannot properly receive the signal light from the group 2, and the OLT6 can determine that at least one among the ONU 65 to the ONU 128 which belong to the group 2 has a malfunction.

In the next stage, the OLT 6 divides group 1 which is determined to include malfunctioning ONU into two groups, and assigns them as a group 1-1 (ONU 1 to ONU 32) and a group 1-2 (ONU 33 to ONU 64). With a similar procedure as mentioned above, the OLT6 successively designates each group, determines the signal light, and identifies groups which include malfunctioning ONUs. At this stage, It is determined that the group 1-1 includes malfunctioning ONUs and all ONUs which belong to the group 1-2 are normal. In the same manner, it refines a group which includes malfunctioning ONUs by repeating the similar procedure, and the ONU 8 is finally identified as the malfunctioning ONU at a time when a number of the ONUs which belongs to a group becames one.

Also, as well as for the group 1, with the same procedure as in the case of the group 1, it can finally identify the malfunctioning ONU 126 in the group 2 which is determined to include malfunctioning ONUs.

In order to identify malfunctioning ONUs, above-described procedure is a procedure where it repeats bisection of a group which includes malfunctioning ONUs until number of the ONUs which belong to the group becomes one. This embodiment has an advantage that it can certainly identify malfunctioning ONUs by automatically repeating simple refinement processes, even if any ideas for the malfunctioning ONUs are previously given such as where they are locating, and how many malfunctioning ONUs are existing. Although an example has been described where groups are simply divided into two as the division method of the group, number of the division is not limited to two, but can be no smaller than three.

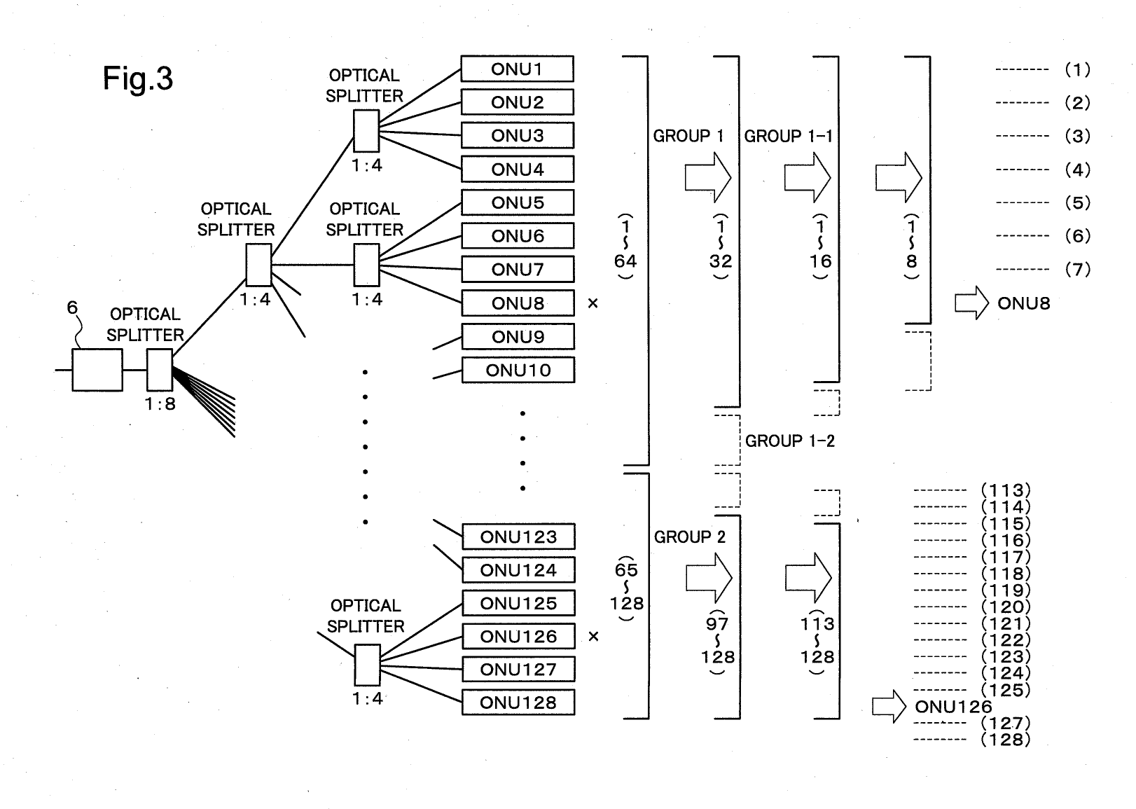

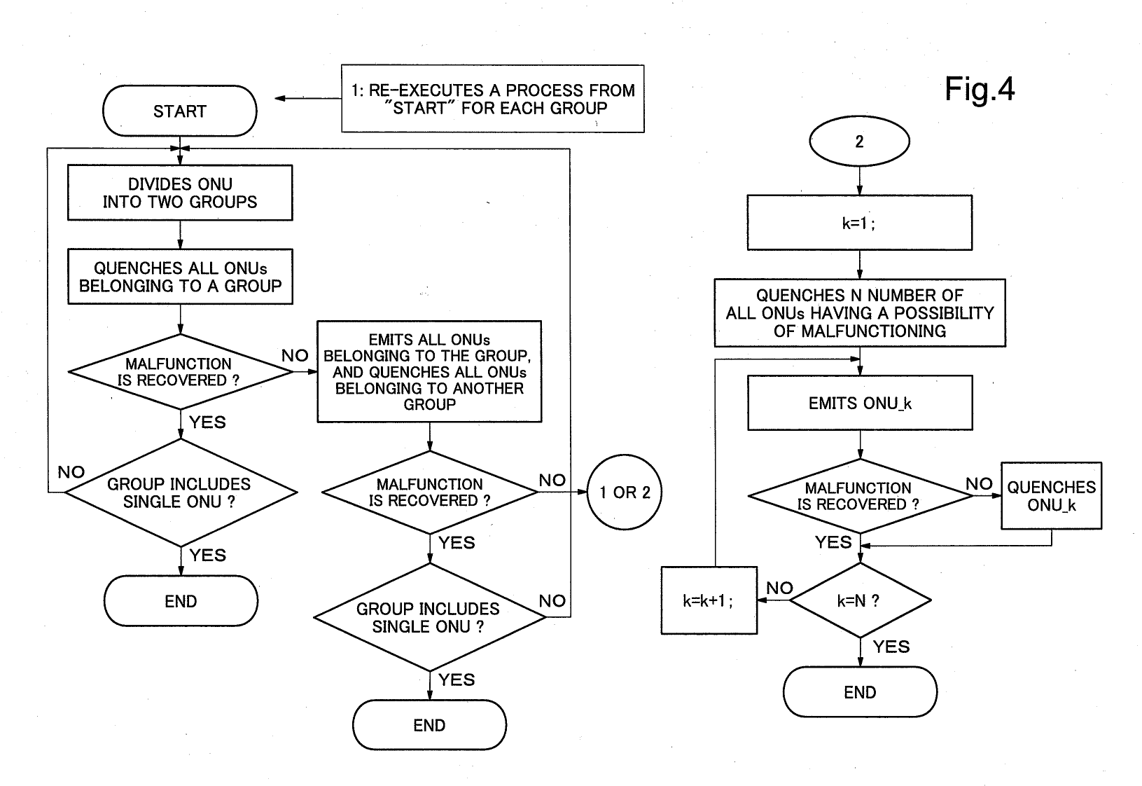

The above described procedure is quite efficient for identifying malfunctioning ONU in the case that number of malfunctioning ONUs is few, because it can exclude a large number of normal ONUs to outside of a scope. However, in the case that a proportion of malfunctioning ONU in the group is increased, the efficiency is decreased. Accordingly, in the case that there exists a large number of malfunctioning ONUs, it may change to a method of determining the signal light of ONU individually in a group when the refinement of the group is progressed to some extent as shown in FIG. 3. In this case, it determines a presence of the malfunction separately by successively designating ONU in the group, stopping emission of all ONUs other than the designated one, and verifying the signal light of the designated ONU. FIG. 4 shows the flowchart which summarized the above-mentioned procedure.

Further, although a method of grouping of ONU is optional, it is considered to be the best approach to divide simply and automatically as mentioned above in the case that less information on factors of malfunction is available. However, in the case that there is a plurality of malfunctioning ONUs, it will be desirable that malfunctioning ONUs are concentrated in a small group as much as possible for the efficient refinement and identification of the malfunctioning ONUs in the group. Accordingly, if the information on factors which may lead to large probability of causing malfunctions is available for the ONUs which are connected with the OLT, the ONUs may be divided into several groups based on these information. These factors may include such as, a specification of the device, a manufacturer, an identification number, a product number, a date of manufacture, an accumulated use time, and a history of malfunction in the past. Then, it is desirable to group together step by step in an order of significance of influence. For example, as shown in FIG. 4, it classifies them on each manufacturer of the ONUs as largest groups, classifies them on each specification as groups under them, classifies them on every six months from the date of manufacture as groups under them, and classifies them on every 10,000 hours of the accumulated running time as groups under them. Note that the OLT may have a function of automatically readouts and registers these attribute information at a time of the registration or while the operation of each ONU. In this way, by grouping together according to the attribute information of the ONUs, a probability of the efficiency of the refinement of the group including malfunctioning ONUs is highly improved.

It is possible to store procedures and data which are used for detecting the malfunction of the optical network devices mentioned above in the storage device installed in the master station device as the program so as to control the operation of the master station device.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

This application is based upon and claims the benefit of priority from Japanese patent application No. 2009-201530, filed on Sep. 1, 2009, the disclosure of which is incorporated herein in its entirety by reference.

1. An optical network device connected with at least two slave station devices via a branched optical fiber, comprising:
a transmission unit which transmits a control signal including an emitting command to, among at least two said slave station devices which are divided into at least two groups that exclusively include said slave station devices, all said slave station devices which belong to a group selected from at least two said groups, transmits a control signal including an eliminating command to all said slave station devices which belong to groups other than said selected group, and executes these light emitting and eliminating control processes for each of at least two said groups; and
a selection and refinement unit which determines for said selected group whether or not it can properly receive a signal light which said slave station device which belong to the group emits after an execution of said light emitting and eliminating control process, and directs said transmission unit to execute said light emitting and eliminating control process for each group which is further divided from a group which is determined that it cannot properly receive the signal light.

2. The optical network device according to claim 1, wherein said selection and refinement unit further comprises:
a unit which repeats said light emitting and eliminating control process for a group which is determined that it cannot properly receive said signal light until number of said slave station devices which belongs to a group becomes one.

3. The optical network device according to claim 1, wherein said selection and refinement unit further comprises a unit for successively designating the slave station device which belongs to a group which is determined that it cannot properly receive said signal light, transmitting said control signal including the emitting command, transmitting said control signal including the eliminating command to all said slave station devices other than the designated slave station device, determining whether or not it can properly receive the signal light which said designated slave station device emits, and identifying a slave station device whereby the signal light cannot be properly received.

4. The optical network device according to claim 1, further comprising:
a unit which divides at least two said slave station devices into groups by rearranging so that one of attribute information is the same or within a range which is defined as a scope of similarities in a same group based on attribute information including a specification, a manufacturer, an identification number, a product number, a date of manufacture, and an accumulated use time for each slave station device.

5. An optical network system, wherein the optical network device according to claim 1 is connected with at least two slave station devices via the branched optical fibers.

6. A malfunction detecting method for the optical network device in the optical network system in which master station device is connected with at least two slave station devices via a branched optical fiber, comprising:
transmitting a control signal including an emitting command to, among at least two said slave station devices which are divided into at least two groups that exclusively include the slave station devices, all said slave station devices which belong to a group selected from said at least two groups, transmitting a control signal including a eliminating command to all said slave station devices which belong to a group other than said selected group, and executing the light emitting and eliminating control processes for each of said at least two groups; and
determining for said selected group whether or not it can properly receive a signal light which said slave station device which belongs to the group emits after an execution of said light emitting and eliminating control process, and executing a selection and refinement which directs said transmission means transmitting to execute said light emitting and eliminating control process for each group which is further divided from the group which is determined that it cannot properly receive the signal light.

7. The malfunction detecting method for the optical network device according to claim 6, wherein said light emitting and eliminating control process are repeated for a group which is determined that it cannot properly receive said signal light until number of said slave station devices which belongs to a group becomes one.

8. The malfunction detecting method for the optical network device according to claim 6, further comprising:
transmitting said control signal including the emitting command after designating successively a slave station device which belongs to a group which is determined that it cannot properly receive said signal light, and transmitting said control signal including the eliminating command to all said slave station devices other than the designated slave station device; and
determining whether or not it can properly receive the signal light which said designated slave station device emits, and identifying a slave station device whereby the signal light cannot be properly received.

9. The malfunction detecting method for the optical network device according to claim 6, further comprising:
dividing at least two said slave station devices into groups by rearranging so that one of attribute information is the same or within a range which is defined as a scope of similarities in a same group based on attribute information including a specification, a manufacturer, an identification number, a product number, a date of manufacture, and an accumulated use time for each slave station device.

10. A recording medium which records a malfunction detecting program of the optical network device in the optical network system where the master station device is connected with at least two slave station devices via a branched optical fiber, said program comprising:
a transmission procedure which transmits a control signal including an emitting command to, among at least two said slave station devices which are divided into at least two groups that exclusively include said slave station devices, all said slave station devices which belong to a group selected from at least two said groups, transmits a control signal including a eliminating command to all said slave station devices which belong to a group other than said selected group, and executes these light emitting and eliminating control processes for each of at least two said groups; and
a selection and refinement procedure which determines for said selected group whether or not it can properly receive a signal light which said slave station device which belongs to the group emits after an execution of said light emitting and eliminating control process, and directs said transmission procedure to execute said light emitting and eliminating control process for each group which is divided further from a group which is determined that it cannot properly receive the signal light.

11. The recording medium which records the malfunction detecting program of the optical network device according to claim 10, further comprising:
a procedure which repeats said light emitting and eliminating control process for a group which is determined that it cannot properly receive said signal light until number of said slave station devices which belongs to the group becomes one.

12. The recording medium which records the malfunction detecting program of the optical network device according to claim 10, further comprising the procedures of:
successively designating slave station devices which belong to a group which is determined that it cannot properly receive said signal light and transmitting said control signal including the emitting command, and transmitting said control signal including the eliminating command to all said slave station devices other than the designated slave station device, and
determining whether or not it can properly receive the signal light which said designated slave station device emits, and identifying a slave station device whereby the signal light cannot be properly received.

13. The recording medium which records the malfunction detecting program of the optical network device according to claim 10, further comprising:
a procedure which divides at least two said slave station devices into groups by rearranging so that one of attribute information is the same or within a range which is defined as a scope of similarities in a same group based on attribute information including a specification, a manufacturer, an identification number, a product number, a date of manufacture, and an accumulated use time for each slave station device.
